(19) United States
(12) Patent Application Publication
(10) Pub. No.: US 2008/0293901 A1
(43) Pub. Date: Nov. 27, 2008

(54) POLYMERS AND COMPOUNDS PREPARED WITH ALPHA-METHYLENE LACTONES, METHODS THEREFOR, AND COATINGS

(75) Inventor: Walter H. OHRBOM, Hartland Township, MI (US)

Correspondence Address: Harness, Dickey and Pierce, P.L.C., 5445 Corporate Drive, Troy, MI, 48098, US

(73) Assignee: BASF CORPORATION

(21) Appl. No.: 11/753,589

(22) Filed: May 25, 2007

(51) Int. Cl. C09D 167/06

(52) U.S. Cl. 526/211; 526/212; 526/89

(57) ABSTRACT

A method of preparing functional materials for coatings, which may be polymers, oligomers, or compounds, includes polymerizing an alpha-methylene lactone that is reacted, before or after polymerization, with a hydroxy-functional reactant. Coating can be prepared with the reaction products.

### FIELD

The present disclosure concerns polymers and compounds prepared with unsaturated lactones, to methods therefor, and to coatings containing such polymers and compounds.

### BACKGROUND

This section provides background information related to the present disclosure that may or may not be prior art.

Clearcoat-basecoat composite coatings are widely used in the coatings industry and are notable for desirable gloss, depth of color, distinctness of image and/or special metallic effects. Composite coatings are particularly utilized by the automotive industry to achieve advantageous visual effects, especially a high degree of gloss and clarity of the clearcoat over the color- and/or effect-providing opaque basecoat.

The clearcoat layer also provides protection of the substrate and lower coating layers from environmental degradation. Curable coating compositions utilizing carbamate-functional resins have been used in coatings and are described, for example, in U.S. Pat. Nos. 5,693,724, 5,693,723, 5,639,828, 5,512,639, 5,508,379, 5,451,656, 5,356,669, 5,336,566, and 5,532,061, each of which is incorporated herein by reference. These coatings can provide significant improvements in resistance to environmental etch over other coatings using other compositions, such as hydroxy-functional acrylic/melamine coating compositions. Coatings with hydroxyl-functional vinyl (especially acrylic) polymers cured using blocked polyisocyanate can also provide excellent resistance to environmental etch in cured coatings. Vinyl polymers prepared from acrylates and methacrylates have been extensively used for topcoats such as automotive clearcoats and basecoats because of the excellent balance of properties they provide in coatings that are tough, durable, and glossy.

U.S. Pat. Nos. 5,693,724, 5,693,723, 5,639,828, 5,512,639, 5,508,379, 5,451,656, 5,356,669, 5,336,566, 5,532,061 and 6531560 describe incorporating carbamate functionality by ‘trans-carbamating’ hydroxyl-functional acrylic resins with hydroxy carbamate compounds. The reaction step is a time-consuming process, however, and produces side products like methanol that, along with other solvents used for the reaction medium, must be removed somehow.

Ohrbom et al., U.S. Pat. Nos. 6,346,591, 6,566,476, 6,624,241, 6,624,275, 6,624,279, and 7,087,675 describe acrylic polymers prepared with beta-hydroxy carbamate functionality and coatings containing these materials. This functionality is prepared by reacting an ethylenically unsaturated monomer having an oxirane group with carbon dioxide to produce a cyclic carbonate group, then reacting the carbonate with ammonia or a primary amine to produce the beta-hydroxy carbamate group. The beta-hydroxy carbamate group may impart water-solubility or water-dispersibility to an addition copolymer made from the ethylenically unsaturated monomer, depending upon how much of this monomer is incorporated into the copolymer.

Alpha-methylene-gamma-butyrolactone has been used as a pest repellent (US Patent Application Publication No. 2006/153890), as an active in cosmetics (US Patent Application Publication No. 2005/277699), in electrolyte solution in batteries (JP Patent Application Publication No. 2005/340151), and as a pain reliever (US Patent Application Publication No. 2005/239,877).

Brandenburg et al., WO 01/64793, describes a coating composition including an acrylic polymer prepared using an exomethylene lactone as a comonomer. Brandenburg et al., WO 01/98410, discloses other compositions in which a copolymer prepared using an exomethylene lactone as a comonomer is combined with an elastomer. Brandenburg et al., WO 02/057362 disclose homopolymers or copolymers prepared using an exomethylene lactone combined with inorganic filler such as alumina trihydrate to make a filled plastic. Finally, Brandenburg et al., WO 03/048220 disclose a graft copolymer of exomethylene lactone onto polymerized butadiene or onto a copolymer of butadiene.

I have now discovered novel monomers and polymers that can be prepared from alpha-methylene lactones such as alpha-methylene-gamma-butyrolactone.

### SUMMARY

I describe a method of preparing functional materials for coatings, which may be polymers, oligomers, or compounds, and coating compositions containing products of these methods, together with the characteristics and benefits of the method and materials. Oligomers are polymers having relatively few monomer units; generally, “oligomer” refers to polymers with ten or fewer monomer units. “Compounds” will refer to nonpolymeric materials.

A reactant with an active hydrogen group reactive with a lactone group under the reaction conditions, such as a hydroxy-functional or a carboxyl-functional material, is reacted with an alpha-methylene lactone having a general structure

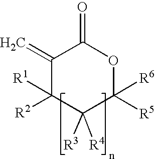

wherein n is 0, 1, or 2; R¹, R², R⁵, and R⁶, and each of R³ and each of R⁴ are independently selected from the group consisting of hydrogen and straight and branched alkyl groups (which may be hydrocarbyl or substituted hydrocarbyl) having 1 to 5 carbon atoms, to provide an ester reaction product.

The reaction product may be further reacted through the hydroxyl or carboxyl group resulting from the ring opening reaction, through another functionality introduced as part of the reactant with an active hydrogen group reactive with a lactone group, or through the ethylenic unsaturation to provide a second reaction product. In one embodiment, the ethylenically unsaturated group is polymerized, particularly through addition polymerization, optionally with one or more further addition polymerizable monomers, and the second reaction product is a polymer or an oligomer.

In a particular example, the alpha-methylene lactone may be reacted with a material having a general structure

HO—R′—F

wherein R′ is selected from linear and branched alkylene, cycloalkylene, and arylene groups, optionally substituted and optionally containing linking groups that include heteroatoms such as nitrogen, oxygen, phosphorous, or sulfur, and F represents a functional group, preferably a curable functional group for a coating composition or a group that is converted to a curable functional group for a coating composition. The reaction product or second reaction product may be incorporated into a coating composition, especially a thermosetting coating composition which may be cured with heat or through exposure to actinic radiation or both.

Also provided is a method in which the lactone having a general structure

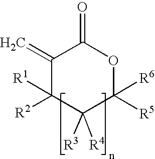

wherein n is 0, 1, or 2; R¹, R², R⁵, and R⁶, and each of R³ and each of R⁴ are independently selected from the group consisting of hydrogen and straight and branched alkyl groups (which may be hydrocarbyl or substituted hydrocarbyl) having 1 to 5 carbon atoms, preferably having a general structure

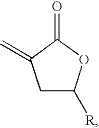

wherein R is selected from the group consisting of hydrogen and straight and branched alkyl groups having 1 to 5 carbon atoms, is addition polymerized through the ethylenic unsaturation to provide a homopolymer or copolymer, then reacted with a material having an active hydrogen group reactive with a lactone group under the reaction conditions, particularly a hydroxyl group, to provide a polymer having pendant ester and hydroxyl groups. The polymer product may be comprise a functionality other than hydroxyl that is introduced as part of the hydroxy-functional material. The polymer product may be incorporated into a coating composition and cured by reaction of its pendant hydroxyl groups or other functionality with a suitable crosslinker or curing agent.

In a particular example, the polymer of the alpha-methylene lactone may be reacted with a material having general structure

HO—R′—F

wherein R′ is selected from linear and branched alkylene, cycloalkylene, and arylene groups, optionally substituted and optionally containing linking groups that include heteroatoms such as nitrogen, oxygen, phosphorous, or sulfur, and F represents a functional group, preferably a curable functional group or a group that is converted, after reaction with the lactone, to a curable functional group.

The method provides a material having at least a plurality of functional groups. The lactone monomer allows manufacture of materials that are otherwise not simple to make and that otherwise use processes that are not straightforward, do not give good yields and/or generate undesirable by-products. This method is a relatively simple and commercially feasible method of making carbamate functional materials, which may have additional functional groups through grafting reactions. This method also facilitates the production of multifunctional vinyl polymers. Such improved polymer manufacturing processes have a decreased risk of uncontrolled molecular weight growth, the loss of desired vinyl backbone functionality, and/or gellation The disclosed methods and products also include crosslinker materials that may react through the lactone and generate hydroxyl groups that may be advantageous for MVSS adhesion in automotive topcoat coatings. The materials made by these methods are particularly useful as a film-forming components in curable film-forming compositions, especially curable coating compositions, whether solventborne compositions, liquid solvent-free compositions, waterborne compositions, electrodeposition compositions, powder compositions, or powder slurry compositions. Automotive applications requiring an optimum balance of finished film properties will particularly benefit from the use of the primary carbamate and multifunctional materials made by these disclosed methods. Finished film-properties that improve with the use of the coating materials prepared by these methods include etch resistance, scratch and marring resistance, UV durability, chip resistance, adhesion, and the like. In addition, a reaction product of the lactone monomer with a polyol provides a product useful in compositions that cure by actinic radiation. The position of the carbon-carbon double bond on a ring allows reasonable reactivity in such actinic radiation-curable compositions, as well in other addition polymerization reactions.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all values and further divided ranges within the entire range.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

The alpha-methylene lactone has a general structure

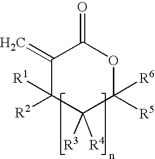

wherein n is 0, 1, or 2; R¹, R², R⁵, and R⁶, and each of R³ and each of R⁴ are independently selected from the group consisting of hydrogen and straight and branched alkyl groups (which may be hydrocarbyl or substituted hydrocarbyl) having 1 to 5 carbon atoms, preferably having a general structure

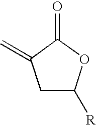

wherein R is selected from the group consisting of hydrogen, and straight and branched alkyl groups having 1 to 5 carbon atoms. U.S. Pat. No. 6,313,318 describes a method for converting certain starting lactones to alpha-methylene substituted lactones using a so-called basic catalyst that is made by treating silica with an inorganic salt of Ba, Mg, K, Cd, Rb, Na, Li, Sr, and La. Alpha-methylene lactones may be prepared by a number of other synthetic methods, including those described in U.S. Patent Application Publications No. 2006/0025612 (published 2 Feb. 2006, inventors Keith W. Hutchenson et al.); 2006/0025611 (published 2 Feb. 2006, inventors Keith W. Hutchenson et al.); 2006/0025610 (published 2 Feb. 2006, inventors Keith W. Hutchenson et al.); 2006/0025609 (published 2 Feb. 2006, inventors Keith W. Hutchenson et al.); 2006/0025608 (published 2 Feb. 2006, inventors Keith W. Hutchenson et al.); 2006/0025605 (published 2 Feb. 2006, inventors Keith W. Hutchenson et al.); 2006/0025607 (published 2 Feb. 2006, inventors Keith W. Hutchenson et al.); and 2006/0025604 (published 2 Feb. 2006, inventors Keith W. Hutchenson et al.), the disclosure of each being incorporated herein by reference. Thus, an alpha-methylene lactone can be prepared by reacting a lactone with formaldehyde at a 150-450° C. in the presence of a porous silica having a pore volume of at least 0.4 cc/g attributable to pores having a diameter between 65 and 3200 Angstroms loaded with sodium, potassium, rubidium, cesium, or barium, heated to 350-550° C. and oxygenated. Nonlimiting examples of alpha-methylene substituted lactones include alpha-methylene-gamma-butyrolactone and methyl alpha-methylene-gamma-butyrolactone, and hydroxyl alpha-methylene-gamma butyrolactone.

A reactant with an active hydrogen group reactive with a lactone group is reacted with the alpha-methylene lactone. Active hydrogen groups reactive with a lactone group include, without limitation, hydroxyl groups, carboxyl groups, primary and secondary amine groups, and thiols. In one embodiment, the reactant is a hydroxy-functional material having a general structure

HO—R′—F

wherein R′ is selected from linear and branched alkylene, cycloalkylene, and arylene groups, optionally substituted, and F represents a functional group, preferably a curable functional group or a group that is converted to a curable functional group after reaction of the compound with the lactone. Nonlimiting examples of functional groups F include carboxyl, epoxide, carbamate, cyclic carbonate, phosphate, phosphonate, amine, aminomalkylol (particularly aminomethylol), aminoalkylol alkyl ether, thiol, and ethylenically unsaturated groups. The term “carbamate group” as used in connection with the present invention refers to a group having a structure:

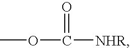

in which R is H or alkyl, preferably R is H or alkyl of from 1 to about 8 carbon atoms, more preferably R is H or alkyl of from 1 to about 4 carbon atoms, and yet more preferably R is H. When R is H, the carbamate group is referred to herein as a primary carbamate group.

The reaction of the lactone with the active hydrogen group can take place before, during, or after a polymerization of the alpha-methylene lactone through its external carbon-carbon double bond. The lactone group is typically reacted with the active hydrogen group at temperatures from about 60 to about 160° C., preferably from about 80 to 140° C., more preferably from about 100 to about 130° C. A catalyst may be used, such as a Lewis acid like dibutyl tin oxide or dibutyl tin dilaurate, stannic octoate, or organic acids such as octanoic acid. Typical catalyst levels for Lewis acids are 0.05 to 5% by weight of reactants, preferably 0.1 to 1% by weight of reactants, while organic acids may be used as catalysts at higher levels, such as 0.1 to 10% by weight of reactants, preferably 1 to 5% by weight of reactants. Sometimes, acid functional vinyl monomers (acrylic acid, methacrylic acid) may function as catalysts. The reaction of the lactone with the active hydrogen material can be carried out neat or in an invert solvent. Nonlimiting examples of suitable solvents include aliphatic and aromatic hydrocarbons, esters, ethers, and ketones. If the active hydrogen material has a further functionality that is not intended to react during the reaction with the lactone group, it may be necessary to protect the further functionality. For example, a primary amine group may be protected by forming a ketimine, an isocyanate group may be blocked with an low molecular weight alcohol or caprolactam, and so on.

It is desirable to minimize self-polymerization, that is, reaction of the lactone with a hydroxyl-functional product of the lactone with the active hydrogen group. Self-polymerization can be minimized by using an excess of the active hydrogen material, by using a bulky alkylene group as the R′ group adjacent the lactone-reactive group, or by using an alkali metal salt or alkaline earth metal salt in place of the active hydrogen product (i.e., MO—R′—F. where M is an alkali metal or alkaline earth metal). In the latter case, the hydroxyl group can be regenerated with water or acidic water following reaction of all of the lactone with the active hydrogen material. These strategies for minimizing self-polymerization can be used in combination with one another, or with other such strategies.

In certain embodiments, the active hydrogen-functional material has more than one functional group other than the active hydrogen group. In such a situation, the functional groups other than the active hydrogen group may be all the same or may be of more than one kind. For example, the active hydrogen-functional material may have a combination of primary carbamate, carbonate, epoxide, carboxylic acid, aminomethylol, aminomethylol alkyl ether, and ethylenically unsaturated groups, and may include blocked isoyanate, hydroxyl, and silyl groups. If desired, these functional groups can be converted into different functional groups following reaction with the lactone ring. Non-limiting examples include conversion of an epoxide group into a beta-hydroxy ester by reaction with a carboxyl group, conversion of an epoxide group into a beta-hydroxy ester and a carboxyl group by reaction with a cyclic anhydride, conversion of a cyclic carbonate into a hydroxy carbamate by reaction with ammonia or a primary amine,

Nonlimiting examples of hydroxy-functional reactant materials include hydroxyalkyl carbamate compounds such as hydroxyethyl carbamate and hydroxypropyl carbamate, hydroxyalky cyclic carbonates such as glycerine carbonate, epoxides such as glycidol, hydroxyacids such as hydroxydimethylacetic acid, and hydroxyamines such as ethanolamine, and dimethylethanolamine.

In certain embodiments, a functionality of the hydroxy-functional material may be converted to another functionality following reaction of the hydroxy-functional material with the alpha-methylene lactone. For example, a cyclic carbonate group may be converted to a carbamate group by reaction with ammonia or a primary amine; an activated amine such as a primary carbamate can be reacted with formaldehyde or other aldehyde to form an aminoplast group, epoxide can be reacted with a carboxylic acid to form a hydroxy group, and protecting or masking groups may be removed, e.g. with heat or water. In special cases, the group used to change the functional group on the lactone-modified material may contain additional functional groups. for example, the reaction of epoxide with acrylic acid produces a product with both a hydroxyl group and an ethylenically unsaturated group from the acrylic portion, which may be used for UV curing.

The ester product of the alpha-methylene lactone and the hydroxy-functional material can be polymerized through the alpha methylene group to form a homopolymer or copolymerized with other addition polymerizable monomers to form a copolymer. Examples of such comonomers include, without limitation, α,β-ethylenically unsaturated monocarboxylic acids containing 3 to 5 carbon atoms such as acrylic, methacrylic, and crotonic acids and the esters of those acids; α,β-ethylenically unsaturated dicarboxylic acids containing 4 to 6 carbon atoms and the anhydrides, monoesters, and diesters of those acids; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic and cycloaliphatic alcohols containing 1 to 20 carbon atoms, such as methyl, ethyl, propyl, isopropyl, n-butyl, isobutyl, tert-butyl, 2-ethylhexyl, lauryl, stearyl, cyclohexyl, trimethylcyclohexyl, tetrahydrofurfuryl, stearyl, sulfoethyl, and isobornyl acrylates, methacrylates, and crotonates. Representative examples of other ethylenically unsaturated polymerizable monomers include, without limitation, such compounds as fumaric, maleic, and itaconic anhydrides, monoesters, and diesters with alcohols such as methanol, ethanol, propanol, isopropanol, butanol, isobutanol, and tert-butanol. Representative examples of polymerization vinyl monomers include, without limitation, such compounds as vinyl acetate, vinyl propionate, vinyl ethers such as vinyl ethyl ether, vinyl and vinylidene halides, and vinyl ethyl ketone. Representative examples of aromatic or heterocyclic aliphatic vinyl compounds include, without limitation, such compounds as styrene, α-methyl styrene, vinyl toluene, tert-butyl styrene, and 2-vinyl pyrrolidone. The comonomers may be used in any desired combination to produce desired vinyl or acrylic polymer properties.

The homopolymer or copolymer may be prepared using conventional techniques, such as by heating the monomers in the presence of a polymerization initiating agent and optionally chain transfer agents. The polymerization is preferably carried out in solution, although it is also possible to polymerize the acrylic polymer in bulk. Suitable polymerization solvents include, without limitation, esters, ketones, ethylene glycol monoalkyl ethers and propylene glycol monoalkyl ethers, alcohols, and aromatic hydrocarbons such as xylene, toluene, and Aromatic 100. In certain cases, the solvent used for the polymerization can comprises the reactant with the active hydrogen group that reactant with the lactone group, for instance alcoholic solvents like butanol or methoxypropanediol may be used as a polymerization solvent.

Typical initiators are organic peroxides such as dialkyl peroxides such as di-tert-butyl peroxide, peroxyesters such as tert-butyl peroctoate and tert-butyl peracetate, peroxydicarbonates, diacyl peroxides, hydroperoxides such as tert-butyl hydroperoxide, and peroxyketals; azo compounds such as 2,2′azobis(2-methylbutanenitrile) and 1,1′-azobis(cyclohexanecarbonitrile); and combinations of these. Typical chain transfer agents are mercaptans such as octyl mercaptan, n- or tert-dodecyl mercaptan; halogenated compounds, thiosalicylic acid, mercaptoacetic acid, mercaptoethanol, and dimeric alpha-methyl styrene.

The solvent or solvent mixture may be heated to the reaction temperature and the monomers and initiator(s) and optionally chain transfer agent(s) added at a controlled rate over a period of time, typically from about two to about six hours. The polymerization reaction may usually be carried out at temperatures from about 20° C. to about 200° C. The reaction may conveniently be done at the temperature at which the solvent or solvent mixture refluxes, although with proper control a temperature below the reflux may be maintained. The initiator should be chosen to match the temperature at which the reaction is carried out, so that the half-life of the initiator at that temperature should preferably be no more than about thirty minutes, more preferably no more than about five minutes. Additional solvent may be added concurrently. The mixture may be held at the reaction temperature after the additions are completed for a period of time to complete the polymerization. Optionally, additional initiator may be added to ensure complete conversion of monomers to polymer.

The acrylic polymer may have a weight average molecular weight of at least about 2400, in some embodiments at least about 3000, in additional embodiments at least about 3500, and in certain preferred embodiments at least about 4000. Weight average molecular weight may be determined by gel permeation chromatography using polystyrene standard. In addition, the weight average molecular weight of certain embodiments may be up to about 5000, in some embodiments up to about 4750, and in still other embodiments up to about 4500. The acrylic polymer having a curable functionality such as carbamate functionality may have an equivalent weight, based on the curable functionality, of up to about 700 grams per equivalent, in some embodiments up to about 500 grams per equivalent, and in some embodiments up to about 425 grams per equivalent. The equivalent weight may be at least about 350 grams per equivalent.

In an alternative method, the alpha-methylene lactone can first be polymerized through the alpha methylene group to form a homopolymer or copolymerized with other addition polymerizable monomers to form a copolymer, and then the pendent lactone groups can be reacted with the material having an active hydrogen group, such as hydroxyl group, to provide a polymer having pendant ester and hydroxyl groups. The material having an active hydrogen group such as a hydroxyl group may also have another functional group other than the active hydrogen group such as hydroxyl to introduce a different functionality other than hydroxyl to the polymer. In a particular example, the polymer of the alpha-methylene lactone may be reacted with a material having general structure

HO—R′—F

wherein R′ is defined as before. Nonlimiting examples of functional groups F include all of those already mentioned, and nonlimiting examples of hydroxy-functional reactant materials include those already mentioned. In certain preferred embodiments the hydroxy-functional reactant is a hydroxyalkyl carbamate compound.

Once again, in certain embodiments, a functionality of the active hydrogen- (e.g., hydroxy-) functional material may be converted to another functionality following reaction of the active hydrogen-functional material with the polymer prepared by polymerizing alpha-methylene lactone. For example, a cyclic carbonate group may be converted to a carbamate group by reaction with ammonia or a primary amine.

The polymers and copolymers prepared by these methods may incorporated into coating compositions. In preferred embodiments, the coating compositions are thermosetting. Such coating compositions may be used to coating automotive and industrial substrates. The industrial and automotive coatings may be primers or topcoats, including one-layer topcoats and basecoat/clearcoat composite coatings.

The thermosetting coating composition preferably further includes a curing agent or crosslinker that is reactive with the one or both of the hydroxyl and any additional functionality of the polymer. The curing agent has, on average, at least about two reactive functional groups. The functional groups may be of more than one kind, each kind being reactive with groups on the polymer.

Useful curing agents include materials having active methylol or methylalkoxy groups, such as aminoplast crosslinking agents or phenol/formaldehyde adducts; curing agents that have isocyanate groups, particularly blocked isocyanate curing agents, curing agents that have epoxide groups, amine groups, acid groups, siloxane groups, cyclic carbonate groups, and anhydride groups; and mixtures thereof. Examples of preferred curing agent compounds include, without limitation, melamine formaldehyde resin (including monomeric or polymeric melamine resin and partially or fully alkylated melamine resin), blocked or unblocked polyisocyanates (e.g., toluene diisocyanate, MDI, isophorone diisocyanate, hexamethylene diisocyanate, biurets, allophanates, and isocyanurates of these, which may be blocked for example with, e.g., alcohols, pyrazole compounds, or oximes), urea resins (e.g., methylol ureas such as urea formaldehyde resin, alkoxy ureas such as butylated urea formaldehyde resin), polyanhydrides (e.g., polysuccinic anhydride), and polysiloxanes (e.g., trimethoxy siloxane). Another suitable crosslinking agent is tris(alkoxy carbonylamino) triazine (available from Cytec Industries under the tradename TACT). The curing agent may be combinations of these, particularly combinations that include aminoplast crosslinking agents. Aminoplast resins such as melamine formaldehyde resins or urea formaldehyde resins are especially preferred. Combinations of tris(alkoxy carbonylamino) triazine with a melamine formaldehyde resin and/or a blocked isocyanate curing agent are likewise suitable and desirable. Component (b) may also contain groups that are reactive with the carbamate group of component (a), such as an acrylic polymer containing polymerized isobutoxymethyl acrylamide groups.

In a certain embodiment, the lactone polymer may be reacted with a polyfunctional active hydrogen-functional material to crosslink the lactone polymer. In such a situation, the active hydrogen-functional material is a crosslinker.

A solvent may optionally be utilized in the coating composition used in the practice of the present invention. In general, the solvent can be any organic solvent and/or water. In one preferred embodiment, the solvent is a polar organic solvent. More preferably, the solvent is selected from polar aliphatic solvents or polar aromatic solvents. Still more preferably, the solvent is a ketone, ester, acetate, aprotic amide, aprotic sulfoxide, aprotic amine, or a combination of any of these. Examples of useful solvents include, without limitation, methyl ethyl ketone, methyl isobutyl ketone, m-amyl acetate, ethylene glycol butyl ether-acetate, propylene glycol monomethyl ether acetate, xylene, N-methylpyrrolidone, blends of aromatic hydrocarbons, and mixtures of these. In another preferred embodiment, the solvent is water or a mixture of water with small amounts of co-solvents.

Coating compositions can be coated on the article by any of a number of techniques well-known in the art. These include, for example, spray coating, dip coating, roll coating, curtain coating, and the like. For automotive body panels, spray coating is preferred.

The coating compositions of the invention include electrocoat primer compositions, primer surfacer compositions, and topcoat compositions, including one-layer pigmented topcoat compositions as well as clearcoat and basecoat two-layer topcoat compositions. When the resins of the invention are utilized in aqueous compositions, they may include monomers with groups that can be salted, i.e., acid groups or amine groups. In the case of electrocoat primer compositions, an acid group or amine group is used to deposit the resin on the anode or cathode.

Additional agents, for example surfactants, fillers, stabilizers, wetting agents, dispersing agents, adhesion promoters, UV absorbers, hindered amine light stabilizers, etc. may be incorporated into the coating composition. While such additives are well-known in the prior art, the amount used must be controlled to avoid adversely affecting the coating characteristics.

When the coating composition of the invention is used as a high-gloss pigmented paint coating, the pigment may be any organic or inorganic compounds or colored materials, fillers, metallic or other inorganic flake materials such as mica or aluminum flake, and other materials of kind that the art normally includes in such coatings. Pigments and other insoluble particulate compounds such as fillers are usually used in the composition in an amount of 1% to 100%, based on the total solid weight of binder components (i.e., a pigment-to-binder ratio of 0.1 to 1).

The coating compositions described herein are preferably subjected to conditions so as to cure the coating layers. Although various methods of curing may be used, heat-curing is preferred. Generally, heat curing is effected by exposing the coated article to elevated temperatures provided primarily by radiative heat sources. Curing temperatures will vary depending on the particular blocking groups used in the cross-linking agents, however they generally range between 90° C. and 180° C. The first compounds according to the present invention are preferably reactive even at relatively low cure temperatures. Thus, in a preferred embodiment, the cure temperature is preferably between 115° C. and 150° C., and more preferably at temperatures between 115° C. and 140° C. for a blocked acid catalyzed system. For an unblocked acid catalyzed system, the cure temperature is preferably between 80° C. and 100° C. The curing time will vary depending on the particular components used, and physical parameters such as the thickness of the layers, however, typical curing times range from 15 to 60 minutes, and preferably 15-25 minutes for blocked acid catalyzed systems and 10-20 minutes for unblocked acid catalyzed systems.

In another embodiment, the hydroxy-functional reactant is a polyol, and the product of the alpha-methylene lactone and the polyol reactant is a material having at least two ethylenically unsaturated groups. Polyol compounds that may be used as the hydroxy-functional reactant include, without limitation, aliphatic polyols such as dodecanediol, derivatives of naturally occurring materials such as dimer fatty acid diol (available from Unequema under the trade name Pripol 2033), isocyanaturate-based polyols such as tris-hydroxyethyl isocyanurate, polyester polyols such as those derived from reaction of epsilon-caprolactone with polyols (available from Dow Chemical under the tradename TONE), diols with one or more further functionalies such as dimethanolpropionic acid, and polyols that contain ether, ester, urea, urethane, or other linking groups.

It is also possible to prepare a material having at least two ethylenically unsaturated groups from the alpha-methylene lactone by selecting reactant conditions so that a second molecule of alpha-methylene lactone reacts with the hydroxy group generated during reaction of the hydroxy-functional reactant with a first molecule of alpha-methylene lactone. This can be done, e.g., by having a two-fold molar excess of the hydroxy-functional reactant. More than two moles of alpha-methylene lactone could react with each mole of the hydroxy-functional reactant to provide a reaction product that has more than two ethylenically unsaturated groups.

The product of the alpha-methylene lactone with a polyol or of more than one molecule of the alpha-methylene lactone with a active hydrogen-functional reactant such as a hydroxy-functional reactant may be incorporated into a coating composition curable by actinic radiation. optionally along with other radiation curable monomers and oligomers. Useful examples of suitable monofunctional and polyfunctional acrylate and vinyl monomers include, without limitation, alkylenediol diacrylates such as 1,6-hexanediol diacrylate and neopentylglycol diacrylate, cyclohexanedimethanol diacrylate, polyalkylene glycol di(meth)acrylates such as triethylene glycol diacrylate, ether modified monomers such as propoxylated neopentylglycol diacrylate, and higher functionality monomers such as trimethylolpropane triacrylate, trimethylolethane triacrylate, and pentaerythritol tetracrylate, and so on, as well as combinations of such polyfunctional monomers. The ink further can include a reactive oligomer. Examples of suitable reactive oligomers include, without limitation, oligomers having at least one, preferably more than one, ethylenically unsaturated double bonds, such as acrylated epoxy oligomers, acrylated polyurethane oligomers, acrylated polyester oligomers, and combinations of these.

The compositions containing reaction products of the alpha-methylene lactone and hydroxy-functional reactant that have more than one ethylenically unsaturated group can be cured and hardened by exposure to actinic radiation, thermal energy, or both actinic radiation and thermal energy. Actinic radiation includes electromagnetic radiation, such as visible light, UV radiation or X-rays, and corpuscular radiation such as electron beams. If cured by UV light, the compositions will typically comprise at least one photoinitiator, or photoinitiator package. If present, the photoinitiator package typically comprises from about 5% to about 15% of the total binder (that is, reactive materials) by weight. Non-limiting examples of photoinitiators include alpha-hydroxy ketones such as 1-hydroxy-cyclohexyl-phenyl-ketone; alpha aminoketones such as 2-benzyl-2-(dimethylamino)-1-(4-morpholinyl)phenyl)-1-butanone; acyl phosphines such as Diphenyl(2,4,6-trimethylbenzoyl)phosphine oxide; benzophenone derivatives; thioxanthones such as isopropylthioxanthone (ITX); and amine co-initiators such as ethyl-p-dimethyl amino benzoate. If cured by electron beam technology, no photoinitiator package would be required for a predominantly acrylate based composition.

In other embodiments, the product of the alpha-methylene lactone with a polyol or of more than one molecule of the alpha-methylene lactone with a hydroxy-functional reactant may be used to prepare a microgel useful as a rheology control agent. The rheology control agent is a photocurable oligomer, which is combined with a photoinitiator that absorbs light to cause the reaction of the rheology control agent to form the microgel. In still other embodiments, the product of the alpha-methylene lactone with a active hydrogen material, especially with a polyol, can be incorporated into a UV cure coating, and cured using UV radiation in the presence of a photoinitiator, or used in a dual-cure UV cure/thermal cure coating, which may then be cured through reaction of alpha-methylene group or both through reaction of the alpha-methylene group and through a functionality introduced by reaction of the lactone ring with the active hydrogen material.

The invention is further described in the following example. The example is merely illustrative and does not in any way limit the scope of the invention as described and claimed. All parts are parts by weight unless otherwise noted.

### EXAMPLES

### Example 1

A solution of 40 parts by weight anhydrous amyl acetate is heated under an inert atmosphere to 135° C. Then a mixture of 25 parts by weight of 3-methylene-dihydrofuran-2-one, 20 parts by weight of butyl acrylate, 7 parts by weight of styrene, and 5 parts by weight of 2,2′-dimethyl-2,2′-azodibutyronitrile is added over four hours. Next, 3 parts by weight of anhydrous amyl acetate are added and the reaction mixture is held for one hour. The final resin has a nonvolatile content of 61% by weight and a lactone equivalent weight of 392 grams per equivalent on solution.

### Example 2

To 100 parts by weight of the resin from Example 1 are added 61 parts by weight of hydroxypropyl carbamate. The reaction mixture is then heated to 125° C. while inert air is bubbled through the mixture. Then 2 parts by weight of tin octoate are added. After the reaction is complete, the resulting resin has a carbamate and hydroxy equivalent weight of 455 grams per equivalent on solution.

### Example 3

While under an inert atmosphere, 1.8 parts by weight of lithium metal is added to a room temperature solution of 30.3 parts by weight hydroxypropyl carbamate in 30 parts by weight of anhydrous amyl acetate. The reaction mixture is then held at 30° C. until the reaction is complete. Next, 100 parts by weight of the resin from Example 1 are added. The reaction mixture is then held below 90° C. until the reaction is complete. The mixture is then cooled to room temperature and 10 parts by weight of water are added. The water and lithium hydroxide are then removed. The final resin will have a carbamate and hydroxy equivalent weight of 635 grams per equivalent on solution.

### Example 4

A clearcoat coating composition is prepared by mixing 1000 g of Example 2, 337.4 g monomeric fully methylolated melamine, and 6.1 g dodecylbenzyl sulfonic acid. This composition is spray-applied to a variety of substrates using a conventional air atomization siphon spraygun, wet-on-wet over conventional high solids basecoat. A conventional, high solids hydroxyl-functional acrylic and melamine-type basecoat composition is used, with a ten-minute ambient flash before application of the clearcoat composition. After an additional five-minute ambient flash, the coated substrate is baked at 250° F. for 30 minutes to provide a cured clearcoat-basecoat composite coating film.

The invention has been described in detail with reference to preferred embodiments thereof. It should be understood, however, that variations and modifications can be made within the spirit and scope of the invention and of the following claims.

What is claimed is:

1. A method of preparing a coating composition, comprising
reacting together an alpha-methylene lactone and an active hydrogen-functional reactant to form a first reaction product;
addition polymerizing the first product to form a polymer; and
incorporating the polymer into a coating composition.

2. A method according to claim 1, wherein the alpha-methylene lactone has a structure 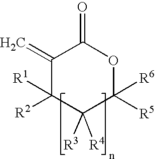
wherein n is 0, 1, or 2; R¹, R², R⁵, and R⁶, and each of R³ and each of R⁴ are independently selected from the group consisting of hydrogen and straight and branched alkyl groups (which may be hydrocarbyl or substituted hydrocarbyl) having 1 to 5 carbon atoms.

3. A method according to claim 1, wherein the alpha-methylene lactone has a structure 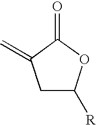
wherein R is selected from the group consisting of hydrogen and straight and branched alkyl groups having up to 5 carbon atoms.

4. A method according to claim 3, wherein R is hydrogen or methyl.

5. A method according to claim 1, wherein the active hydrogen-functional reactant has a general structure
HO—R′—F
wherein R′ is selected from linear and branched alkylene, cycloalkylene, and arylene groups, optionally substituted, and F represents a functional group.

6. A method according to claim 5, wherein F represents a functional group that reacts when the coating composition is cured.

7. A method according to claim 6, wherein F is selected from the group consisting of carboxyl, epoxide, carbamate, cyclic carbonate, phosphate, phosphonate, amine, aminomethylol, aminomethylol alkyl ether, thiol, and ethylenically unsaturated groups.

8. A method according to claim 1, wherein the active hydrogen-functional reactant has a hydroxyl group as the active hydrogen group and has a further functional group other than the hydroxyl group.

9. A method according to claim 1, wherein the active hydrogen-functional reactant is a hydroxyalkyl carbamate.

10. A method according to claim 1, wherein the active hydrogen-functional reactant has a first kind of functionality that is converted to a second kind of functionality after the first reaction product is formed.

11. A method of preparing a coating composition, comprising
polymerizing alpha-methylene lactone to form a first polymer;
reacting with the first polymer an active hydrogen-functional reactant to form a second polymer; and
incorporating the second polymer into a coating composition.

12. A method according to claim 10, wherein the alpha-methylene lactone has a structure 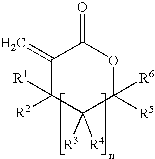
wherein n is 0, 1, or 2; R¹, R², R⁵, and R⁶, and each of R³ and each of R⁴ are independently selected from the group consisting of hydrogen and straight and branched alkyl groups (which may be hydrocarbyl or substituted hydrocarbyl) having 1 to 5 carbon atoms.

13. A method according to claim 11, wherein the alpha-methylene lactone has a structure 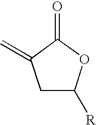
wherein R is selected from the group consisting of hydrogen and straight and branched alkyl groups having up to 5 carbon atoms.

14. A method according to claim 13, wherein R is hydrogen or methyl.

15. A method according to claim 11, wherein the active hydrogen-functional reactant has a general structure
HO—R′—F
wherein R′ is selected from linear and branched alkylene, cycloalkylene, and arylene groups, optionally substituted, and F represents a functional group.

16. A method according to claim 15, wherein F represents a functional group that reacts when the coating composition is cured.

17. A method according to claim 16, wherein F is selected from the group consisting of carboxyl, epoxide, carbamate, cyclic carbonate, phosphate, phosphonate, amine, aminomethylol, aminomethylol alkyl ether, thiol, and ethylenically unsaturated groups.

18. A method according to claim 11, wherein the active hydrogen-functional reactant has a further functional group other than the active hydrogen group.

19. A method according to claim 11, wherein the active hydrogen-functional reactant is a hydroxyalkyl carbamate.

20. A method according to claim 11, wherein the active hydrogen-functional reactant has a first kind of functionality that is converted to a second kind of functionality after the first reaction product is formed.

21. A coating composition prepared according to claim 1.

22. A coating composition prepared according to claim 11.

23. A method of preparing a coating composition, comprising:
reacting together an alpha-methylene lactone and a hydroxy-functional reactant to form a reaction product containing more than one alpha-methylene lactone and
incorporating the reaction product into a coating composition.

24. A method according to claim 23, wherein the hydroxy-functional reactant is a polyol.

25. A method according to claim 23, wherein a second molecule of alpha-methylene lactone reacts with the hydroxy group generated during reaction of the hydroxy-functional reactant with a first molecule of alpha-methylene lactone.

26. A coating composition prepared according to the method of claim 23, wherein the coating composition is curable by exposure to actinic radiation.

27. A method of preparing a coating composition, comprising:
reacting together an alpha-methylene lactone and a hydroxy-functional reactant to form a reaction product containing more than one alpha-methylene lactone;
polymerizing the reaction product to form a crosslinked microgel;
incorporating the crosslinked microgel into a coating composition.

28. A coating composition prepared by the method of claim 27.
